(19) United States
(12) Patent Application Publication
(10) Pub. No.: US 2026/0241610 A1
(43) Pub. Date: Aug. 20, 2026

(54) BAND SAW CUTTING MACHINE

(71) Applicant: NACHI-FUJIKOSHI CORP., Tokyo (JP)

(72) Inventor: Yuki TAKENAKA, Toyama (JP)

(73) Assignee: NACHI-FUJIKOSHI CORP., Tokyo (JP)

(21) Appl. No.: 19/531,672

(22) Filed: Feb. 6, 2026

(30) Foreign Application Priority Data
Feb. 17, 2025 (JP) 2025-023628

(51) Int. Cl. B28D 5/00; B28D 5/04

(52) U.S. Cl. CPC B28D 5/0064; B28D 5/045

(57) ABSTRACT

A band saw cutting machine includes: a pulley movement driver for moving pulleys in a cutting direction; a band saw stretched between the pulleys; a cylinder that biases a pulley shaft on a driven pulley shaft to apply tension to the band saw; servo motors for adjusting inclination angles of the pulley shafts; sensors fixed at a position adjacent to the pulleys and measuring distances to the surface of the band saw; and a controller that continuously measures, by means of the sensors, distances to the surface of the band saw while the band saw is moving to calculate an inclination angle of the band saw and drives the servo motors according to the inclination angle of the band saw to adjust the inclination angles of the pulley shafts.

### CROSS-REFERENCE TO RELATED APPLICATION

This application is based upon and claims the benefit of priority from the prior Japanese Patent Application No. 2025-023628, filed on Feb. 17, 2025, the entire contents of which are incorporated herein by reference.

### BACKGROUND OF THE INVENTION

### Field of the Invention

The present invention relates to a band saw cutting machine for cutting a silicon ingot.

### Background Art

A silicon ingot is a columnar material that serves as a raw material for semiconductor elements, and wafers are manufactured by cutting the silicon ingot into a predetermined thickness with a cutting tool (cutting blade) such as a band saw. In order to make a cut surface flat, it is important to apply an appropriate tension to a blade portion located at a lower edge of the band saw.

The band saw is wound around a pair of pulleys and travels between the pair of pulleys. When an appropriate tension is applied to the blade portion of the band saw, the band saw is firmly stretched over the pair of pulleys, and the tension of the band saw is maintained uniformly. As a result, vibration of the band saw during travel is suppressed, and the machining accuracy for cutting the silicon ingot is improved.

Patent Document 1 discloses an electroplated band saw. This electroplated band saw includes a strip steel serving as a main body and a blade portion in which hard abrasive grains are fixed to one side of the strip steel, and a recess is provided along a longitudinal direction at a center portion in a width direction of the strip steel. The electroplated band saw provided with the recess increases a tension of the blade portion when wound around the pulley, thereby cutting the workpiece with high accuracy.

[Patent Document 1] Japanese Unexamined Patent Application Publication No. 2004-160579

### SUMMARY OF THE INVENTION

In order to solve the above problems, a representative configuration of the band saw cutting machine for cutting a silicon ingot according to the present invention includes: a driving pulley shaft and a driven pulley shaft; pulleys respectively mounted on the driving pulley shaft and the driven pulley shaft and positioned on both sides of the silicon ingot; a pulley movement driver including a base drive motor that moves the pulleys in a cutting direction; a band saw stretched between the pulleys and cutting the silicon ingot by movement of the pulleys; a cylinder that biases the driven pulley shaft applying tension to the band saw; servo motors for respectively adjusting inclination angles of the driving pulley shaft and the driven pulley shaft; sensors fixed at positions adjacent to the pulleys and measuring distances to surfaces of the band saw stretched over the pulleys; and a controller that controls operation of the band saw cutting machine, in which the controller continuously measures, by means of the sensors, distances to the surface of the band saw while the band saw is moving to calculate an inclination angle of the band saw, and the controller drives the servo motors according to the calculated inclination angle of the band saw to adjust the inclination angles of the pulley shafts.

### BRIEF DESCRIPTION OF THE DRAWINGS

FIG. 1 is a diagram showing a configuration of a band saw cutting machine according to an embodiment of the present invention.

FIG. 2 is a diagram illustrating a mechanism for adjusting an inclination angle of a pulley shaft of the band saw cutting machine of FIG. 1.

FIG. 3A shows a state before cutting the silicon ingot.

FIG. 3B shows a state in which the silicon ingot is being cut by the band saw.

FIG. 4 is a flowchart showing an operation during replacement of the band saw by the band saw cutting machine of FIG. 1.

FIG. 5 is a flowchart showing an operation during cutting by the band saw cutting machine of FIG. 1.

### DETAILED DESCRIPTION

Hereinafter, a preferred embodiment of the present invention will be described in detail with reference to the accompanying drawings. Dimensions, materials, and other specific numerical values shown in this embodiment are merely examples for facilitating the understanding of the invention and do not limit the present invention unless otherwise specified. In this specification and drawings, elements having substantially the same function and configuration are given the same reference numerals and their overlapping descriptions are omitted, and elements not directly related to the present invention are omitted from the drawings.

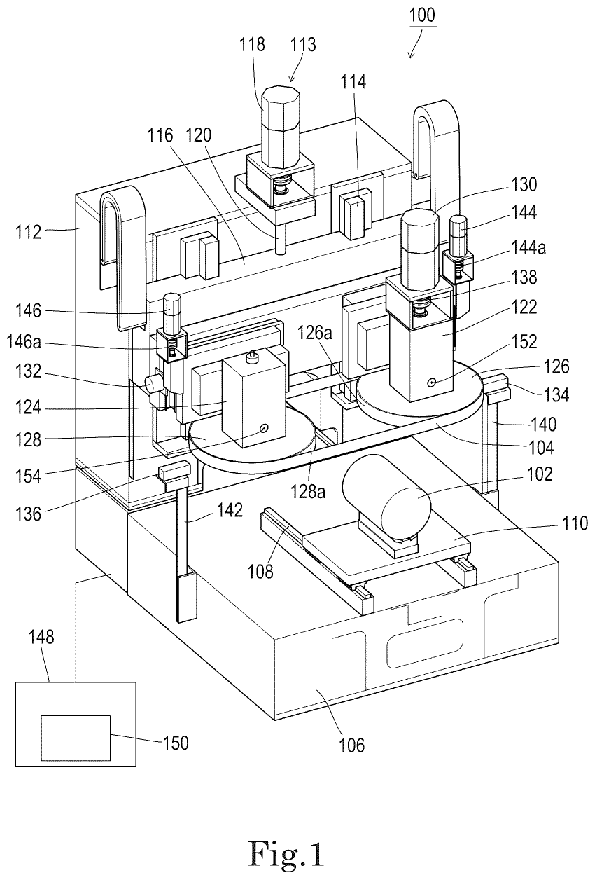

FIG. 1 is a diagram showing a configuration of a band saw cutting machine 100 according to an embodiment of the present invention. The band saw cutting machine 100 is a device for cutting a silicon ingot 102 and includes a band saw 104 that serves as a cutting tool (cutting blade).

The silicon ingot 102 is a cylindrical material that serves as a raw material for semiconductor elements. A wafer is manufactured by cutting the silicon ingot 102 to a predetermined thickness with the band saw 104. When the cutting accuracy of the band saw 104 is high, the cut surface of the silicon ingot 102 becomes flat, resulting in production of the wafers having a quality above a predetermined level. In order to flatten the cut surface of the silicon ingot 102, it is important to apply an appropriate tension to the band saw 104.

Therefore, in the band saw cutting machine 100, a configuration is adopted in which, during the cutting of the silicon ingot 102, the straightness of the band saw 104 relative to the silicon ingot can be continuously and properly maintained, and furthermore, the tension of the band saw 104 can be automatically and optimally adjusted. The following describes the configuration in detail.

The band saw cutting machine 100 includes a base 106 installed on a floor such as that of a factory, two base rails 108, and a table 110. The base rails 108 are fixed to an upper surface of the base 106 and extend horizontally while being arranged parallel to each other. The table 110 is guided to be movable in a horizontal direction relative to the base 106 by means of the base rails 108. The silicon ingot 102 is placed on the table 110.

The band saw cutting machine 100 further includes a column 112 attached to the base 106 and a pulley moving driver 113 that moves the band saw 104 vertically. The pulley moving driver 113 can move a pulley moving driver base 116, to which the pulley shafts 122 and 124 are attached, in a vertical direction relative to the column 112 by driving a base drive motor 118.

The pulley moving driver 113 includes two rails 114, the pulley moving driver base 116, and a base drive motor 118. The rails 114 are fixed to a front surface of the column 112 and extend vertically while being arranged parallel to each other. The pulley moving driver base 116 is assembled to the rails 114 in a manner movable along the rails 114. Therefore, the pulley moving driver base 116 is guided to be movable in the vertical direction relative to the column 112 by means of the rails 114.

The base drive motor 118 is fixed to an upper surface of the column 112. The base drive motor 118 is located between the two rails 114 and further rotates a base drive motor shaft 120. When the base drive motor shaft 120 rotates, the pulley moving driver base 116 moves in a vertical direction.

On the pulley moving driver base 116, a driving pulley shaft 122 and a driven pulley shaft 124 are mounted apart from each other in a lateral direction. A pulley 126 is mounted on a lower end side of the pulley shaft 122 serving as a drive shaft. A pulley 128 is mounted on a lower end side of the pulley shaft 124 serving as a driven shaft.

The pulleys 126 and 128 are positioned on both sides in the lateral direction of the silicon ingot 102. A band saw 104 is mounted between the pulleys 126 and 128. The band saw 104, while being wound around and tensioned between the pulleys 126 and 128, abuts against rubbers 126a and 128a disposed on rims of the pulleys 126 and 128. Then, when the pulley moving driver base 116 moves in the vertical direction, the pulleys 126 and 128 move in a cutting direction (vertical direction) to cut the silicon ingot 102 with the band saw 104.

The band saw cutting machine 100 further includes a belt drive motor 130, a hydraulic cylinder 132, and two sensors 134 and 136. The belt drive motor 130 is installed on an upper end side of the pulley shaft 122 and rotates a belt drive motor shaft 138. When the belt drive motor shaft 138 rotates, the pulley shaft 122 and the pulley 126 on the drive side rotate, and power is transmitted to the pulley 128 through the band saw 104. As a result, the pulley shaft 124 and the pulley 128 on the driven side rotate, and the band saw 104 travels between the pulleys 126 and 128.

The hydraulic cylinder 132 is attached to the pulley moving driver base 116 and biases the driven pulley shaft 124 to apply a tension (basic tensile force) to the band saw 104. The sensors 134 and 136 are distance sensors that measure the distance to the surface of the band saw 104 tensioned between the pulleys 126 and 128. The sensors 134 and 136 are mounted on side surfaces of the base 106 and are supported by support members 140 and 142 extending in the vertical direction. Accordingly, the sensors 134 and 136 are fixed at positions adjacent to the pulleys 126 and 128.

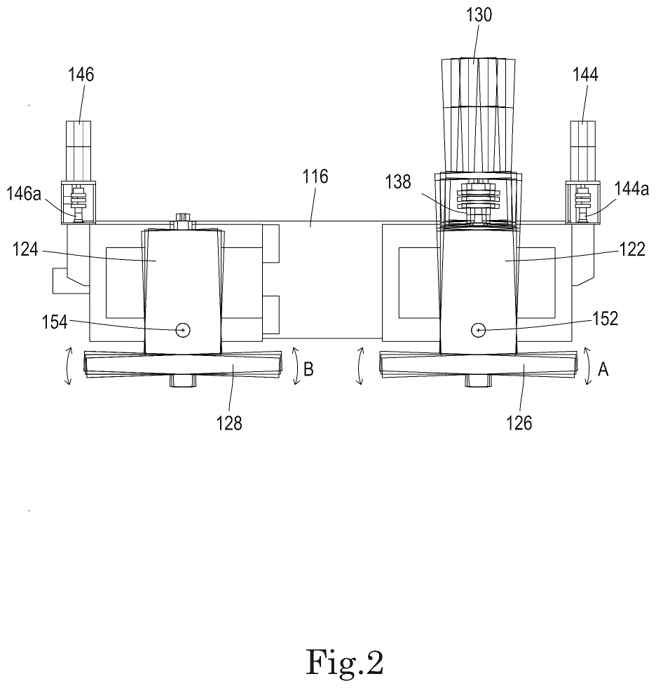

Furthermore, the band saw cutting machine 100 includes two servo motors 144 and 146 and a controller 148. The controller 148 controls an operation of the band saw cutting machine 100. The servo motors 144 and 146 respectively adjust inclination angles of the pulley shafts 122 and 124 by numerical control performed by the controller 148 (see FIG. 2).

The controller 148 includes a storage 150 that stores angle data obtained during production of wafers having the quality above the predetermined level. The angle data obtained during the production of the wafer having the quality above the predetermined level refers to inclination angles of the pulley shafts 122 and 124 when a wafer cut out from the silicon ingot 102 by the band saw 104 is of the quality above the predetermined level.

FIG. 2 is a diagram illustrating a mechanism for adjusting the inclination angles of the pulley shafts 122 and 124 of the band saw cutting machine 100 of FIG. 1. In the figure, the band saw 104 is omitted.

The servo motors 144 and 146 are mounted on the pulley moving driver base 116 and respectively rotate servo motor shafts 144a and 146a. When the servo motor shafts 144a and 146a rotate, the pulley shafts 122 and 124 incline respectively about angle-adjusting center shafts 152 and 154.

As such, in the band saw cutting machine 100, the inclination angles of the pulley shafts 122 and 124 can be respectively adjusted by driving the servo motors 144 and 146. Also, since the pulleys 126 and 128 are mounted on the pulley shafts 122 and 124, the pulleys 126 and 128 respectively incline in the directions indicated by arrows A and B in the figure according to the inclination angles of the pulley shafts 122 and 124.

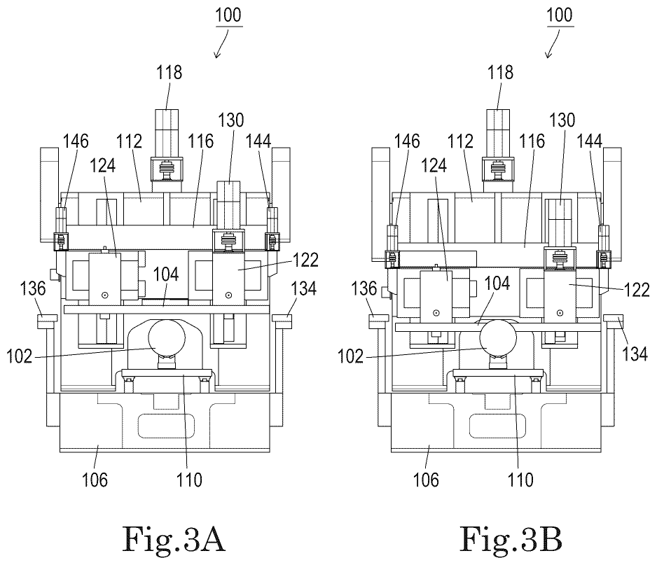

FIG. 3A shows a state before cutting the silicon ingot 102. FIG. 3B shows a state in which the silicon ingot 102 is being cut by the band saw 104. FIGS. 3A and 3B illustrate a method for calculating an inclination angle of the band saw 104.

As described above, the sensors 134 and 136 are fixed at positions adjacent to the pulleys 126 and 128. Therefore, even if the pulleys 126 and 128 move by the pulley moving driver 113, the sensors 134 and 136 do not move. On the other hand, when the pulleys 126 and 128 move from the state shown in FIG. 3A to the state shown in FIG. 3B by means of the pulley moving driver 113, the band saw 104 moves in the cutting direction (vertical direction).

Accordingly, the controller 148 shown in FIG. 1 continuously measures, by means of the sensors 134 and 136 which are distance sensors, the distance to the surface of the band saw 104 while the band saw 104 is moving. Thus, the controller 148 can calculate the inclination angle of the band saw 104 based on the distance and angle to the surface of the band saw 104.

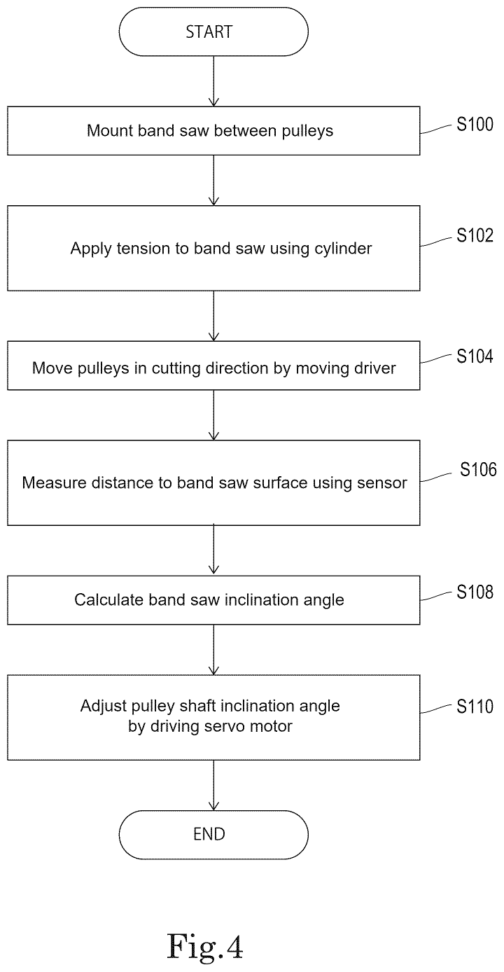

FIG. 4 is a flowchart showing an operation of the band saw cutting machine 100 shown in FIG. 1 during replacement of the band saw 104. For example, a blade portion having hard abrasive grains fixed thereto is formed on the lower edge of the band saw 104. The blade portion of the band saw 104 may deteriorate through repeated cutting of the silicon ingot 102, resulting in a decrease in cutting accuracy. Therefore, in the band saw cutting machine 100, the band saw 104 is periodically replaced.

First, at the time of replacement of the band saw 104 in the band saw cutting machine 100, an operator winds a new band saw 104 around the pulleys 126 and 128 and mounts the band saw 104 between the pulleys 126 and 128 (step S100). Next, the controller 148 controls the hydraulic cylinder 132 to bias the driven pulley shaft 124 and apply tension to the band saw 104 (step S102).

Subsequently, the controller 148 drives the base drive motor 118 of the pulley moving driver 113 to move the pulleys 126 and 128 in the cutting direction (step S104). Further, the controller 148 continuously measures, by means of the sensors 134 and 136, the distance to the surface of the band saw 104 (step S106) and calculates the inclination angle of the band saw 104 (step S108).

Then, the controller 148 drives the servo motors 144 and 146 according to the calculated inclination angle of the band saw 104 to adjust the inclination angles of the pulley shafts 122 and 124 (step S110).

Therefore, according to the band saw cutting machine 100, even after replacement of the band saw 104, the straightness of the new band saw 104 stretched between the pulleys 126 and 128 can be properly maintained, and the tension of the band saw 104 can be automatically and optimally adjusted.

When the cutting of the silicon ingot 102 is repeated, the rubbers 126 a and 128 a of the pulleys 126 and 128, which come into contact with the band saw 104, may deteriorate, and the band saw 104 may become inclined, resulting in a decrease in cutting accuracy. Therefore, in the band saw cutting machine 100, instead of replacing the band saw 104 in step S100, the pulleys 126 and 128 may be replaced, and the subsequent processing may then be executed.

In this manner, even after replacement of the pulleys 126 and 128, the band saw cutting machine 100 can properly maintain the straightness of the band saw 104 and can automatically and optimally adjust the tension of the band saw 104.

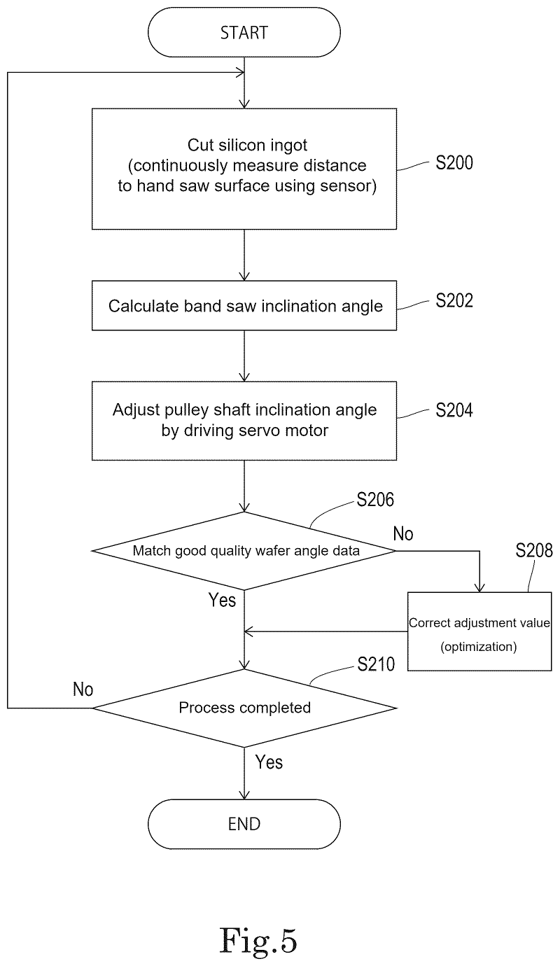

FIG. 5 is a flowchart showing an operation during cutting processing of the band saw cutting machine 100 of FIG. 1. First, in the band saw cutting machine 100, the controller 148 continuously measures, by means of the sensors 134 and 136, the distance to the surface of the band saw 104 during a cutting process in which the silicon ingot 102 is cut by the band saw 104 (step S200).

Next, the controller 148 calculates the inclination angle of the band saw 104 based on the distance and angle to the surface of the band saw 104 (step S202). The controller 148 also drives the servo motors 144 and 146 according to the calculated inclination angle of the band saw 104 to adjust the inclination angles of the pulley shafts 122 and 124 (step S204).

Subsequently, the controller 148 reads out, from the storage 150 (see FIG. 1), the angle data at the time of production of the wafer having the quality above the predetermined level. Then, the controller 148 determines whether the inclination angles of the pulley shafts 122 and 124 adjusted in step S204 match the angle data at the time of the production of the wafer having the quality above the predetermined level (the inclination angles of the pulley shafts 122 and 124 at the time of production of the wafer having the quality above the predetermined level) (step S206).

If both the inclination angles of the pulley shafts 122 and 124 and the angle data at the time of the production of the wafer having the quality above the predetermined level do not match in step S206 (No), the controller 148 corrects and optimizes the adjustment values of the servo motors 144 and 146 so that the inclination angles of the pulley shafts 122 and 124 match the angle data at the time of the production of the wafer having the quality above the predetermined level (step S208).

If both the inclination angles of the pulley shafts 122 and 124 and the angle data at the time of the production of the wafer having the quality above the predetermined level match in step S206 (Yes) or are matched in step S208, the controller 148 determines whether the cutting process of the silicon ingot 102 by the band saw 104 has been completed (step S210).

If the cutting process of the silicon ingot 102 has not been completed in step S210 (No), the controller 148 returns to step S200 to continue the cutting process of the silicon ingot 102, and when the cutting process is completed (Yes), the controller 148 terminates the processing associated with the cutting operation.

Therefore, according to the band saw cutting machine 100, during the cutting process in which the silicon ingot 102 is cut by the band saw 104, the straightness of the band saw 104 can be continuously and properly maintained, and the tension of the band saw 104 can be automatically and optimally adjusted. As a result, even if the inclination angle of the band saw 104 gradually changes relative to the inclination angles of the pulley shafts 122 and 124, the straightness of the band saw 104 can always be maintained. Consequently, the travel of the band saw 104 between the pulleys 126 and 128 becomes stable, and the cutting accuracy of the silicon ingot 102 can be improved. Further, since the tension of the band saw 104 is automatically adjusted, the work efficiency can be enhanced.

As described above, a preferred embodiment of the present invention has been explained with reference to the accompanying drawings, but it goes without saying that the present invention is not limited to such an example. It is obvious to those skilled in the art that various modifications and alterations can be conceived within the scope described in the claims, and it is understood that such modifications and alterations naturally belong to the technical scope of the present invention.

What we claim is:

1. A band saw cutting machine for cutting a silicon ingot, comprising:
a driving pulley shaft and a driven pulley shaft;
pulleys respectively mounted on the driving pulley shaft and the driven pulley shaft and positioned on both sides of the silicon ingot;
a pulley movement driver including a base drive motor that moves the pulleys in a cutting direction;
a band saw stretched between the pulleys and cutting the silicon ingot by movement of the pulleys;
a cylinder that biases the driven pulley shaft applying tension to the band saw;
servo motors for respectively adjusting inclination angles of the driving pulley shaft and the driven pulley shaft;
sensors fixed at positions adjacent to the pulleys and measuring distances to surfaces of the band saw stretched over the pulleys; and
a controller that controls operation of the band saw cutting machine,
wherein the controller continuously measures, by means of the sensors, distances to the surface of the band saw while the band saw is moving to calculate an inclination angle of the band saw, and
wherein the controller drives the servo motors according to the calculated inclination angle of the band saw to adjust the inclination angles of the pulley shafts.

2. The band saw cutting machine according to claim 1, further comprising:
a storage that stores inclination angle data of the pulley shafts when a wafer cut out from the silicon ingot by the band saw is of a quality above a predetermined level, the inclination angle data being stored as angle data at a time of production of the wafer having the quality above the predetermined level,
wherein the controller, when the band saw or the pulleys are replaced or every time the silicon ingot is cut, drives the servo motors based on the angle data at the time of production of the wafer having the quality above the predetermined level read out from the storage, to adjust the inclination angles of the pulley shafts.
